(19) United States
(12) Patent Application Publication
(10) Pub. No.: US 2011/0119079 A1
(43) Pub. Date: May 19, 2011

(54) Connecting Consumers with Service Providers

(75) Inventor: Roy Schoenberg, Boston, MA (US)

(73) Assignee: AMERICAN WELL CORPORATION, Boston, MA (US)

(21) Appl. No.: 12/950,645

(22) Filed: Nov. 19, 2010

Related U.S. Application Data
(60) Provisional application No. 61/262,718, filed on Nov. 19, 2009.

(51) Int. Cl. G06Q 99/00; G06Q 50/00

(52) U.S. Cl. 705/2; 705/319

(57) ABSTRACT

A computer-implemented method includes receiving by a first mobile device an application that executes on the first mobile device associated with a consumer, the application including a plurality of graphical user interfaces, the graphical user interfaces having one or more fields that are populated with information received from a central, brokerage system; sending by the application executing on the first mobile device a request to consult with a service provider; populating one or more fields of the plurality of graphical user interfaces with information received from the central, brokerage system, to render a visual representation of present availability of one or more service providers; receiving by the application a selection of a particular service provider; and establishing through the brokerage system by the application a communication channel between the first mobile device and a second mobile device associated with a selected service provider.

### CLAIM OR PRIORITY

This application claims priority under 35 U.S.C. §119(e) to provisional U.S. Patent Application 61/262,718, filed on Nov. 19, 2009, the entire contents of which are hereby incorporated by reference.

### BACKGROUND

The present invention is directed to connecting consumers with service providers.

Systems have been developed to connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in my issued U.S. Pat. No. 7,590,550, which is incorporated herein by reference.

### SUMMARY

In one aspect of the present disclosure, a computer-implemented method includes receiving by a first mobile device an application that executes on the first mobile device associated with a consumer, the application including a plurality of graphical user interfaces, the graphical user interfaces having one or more fields that are populated with information received from a central, brokerage system; sending by the application executing on the first mobile device a request to consult with a service provider; populating one or more fields of the plurality of graphical user interfaces with information received from the central, brokerage system, to render a visual representation of present availability of one or more service providers; receiving by the application a selection of a particular service provider; and establishing through the brokerage system by the application a communication channel between the first mobile device and a second mobile device associated with a selected service provider.

Implementations of the disclosure may include one or more of the following features. In some implementations, the method further includes receiving from the first mobile device a request for the application; and sending the application to the first mobile device. In other implementations, a first graphical user interface in the plurality of graphical user interfaces includes: a link for each corresponding available service provider, with selection of the link causing generating of a second graphical user interface to be displayed on the first mobile device, the second graphical user interface including one more details of a service provider associated with the selected link.

In other implementations, the method further includes generating, by one or more computers, a first graphical user interface that when rendered on the first mobile device displays one or more first links through which the consumer searches for available service providers. The method may also include generating, by one or more computers, a particular graphical user interface that when rendered on the second mobile device displays, for the service provider, a first link, selection of which indicates that service provider accepts the request, and a second link, selection of which indicates that the service provider declines the request.

In still other implementations, the method includes generating a particular graphical user interface that when rendered on the second mobile device displays for the service provider a visual representation of a measure of estimated demand for a specialty associated with the service provider. In some implementations, a particular graphical user interface when rendered on the second mobile device displays: a link, selection of which allows the service provider to update an availability status of the service provide, and a visual representation of a number of consultations with which the service provider has been engaged, with the number of consultations including one or more of a number of complete consultations, a number of incomplete consultations, and a number of cancelled consultations.

The method may also include generating a particular graphical user interface that when rendered on the second mobile device displays for the service provider a visual representation of one or more of suggested topics to discuss with the consumer of services, a patient health summary, medical conditions associated with the consumer of services, and medication associated with the consumer of services.

In another aspect of the disclosure, a computer program product is embedded in a computer readable medium for providing broker services to consumers and service providers, the computer program product including instructions for causing a first mobile device to: receive an application that executes on a first mobile device associated with a consumer, the application including a plurality of graphical user interfaces, the graphical user interfaces having one or more fields that are populated with information received from a central, brokerage system; and configure the application to: send a request to consult with a service provider; populate one or more fields of the plurality of graphical user interfaces with information received from the central, brokerage system to render a visual representation of present availability of the one or more service providers; receive a selection of a particular service provider; and establish through the brokerage system a communication channel between the first mobile device and a second mobile device associated with a selected service provider. Implementations of this aspect of the present disclosure can include one or more of the foregoing features.

In still another aspect of the disclosure, an apparatus includes a processor; and a computer program product embedded in a computer readable medium for providing broker services to consumers and service providers, the computer program product including instructions for causing the processor to: receive an application that executes on a first mobile device associated with a consumer, the application including a plurality of graphical user interfaces, the graphical user interfaces having one or more fields that are populated with information received from a central, brokerage system; and configure the application to: send a request to consult with a service provider; populate one or more fields of the plurality of graphical user interfaces with information received from the central, brokerage system to render a visual representation of present availability of the one or more service providers; receive a selection of a particular service provider; and establish through the brokerage system a communication channel between the first mobile device and a second mobile device associated with a selected service provider. Implementations of this aspect of the present disclosure can include one or more of the foregoing features.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more embodiments are set forth in the accompanying drawings and the description below. Other features, objects, and advantages will be apparent from the description and drawings, and from the claims.

### BRIEF DESCRIPTION OF THE FIGURES

FIG. 1 is a diagrammatic view of an engagement brokerage service.

FIG. 2 is a flowchart of a process for generating an application.

FIG. 3 is a flowchart of a process for interacting with the brokerage system through an application.

FIGS. 4-11 are screen images of graphical user interfaces of an application rendered for an engagement on a display screen of a mobile device.

FIGS. 12-13 are flow charts of processes used in an engagement brokerage system.

### DETAILED DESCRIPTION

### Overview

The system described below provides an integrated information and communication platform that enables consumers of services to identify and prioritize service providers with whom they should consult and to carry out consultations, over mobile devices and personal digital assistants (“PDAs”), including the BlackBerry® and the Apple iPhone®. Consumers consult on-line and over the consumers' mobile devices with an expert service provider, at a mutually convenient time and place, even when the two parties are geographically separated. This integrated platform is referred to herein as an engagement brokerage service (brokerage).

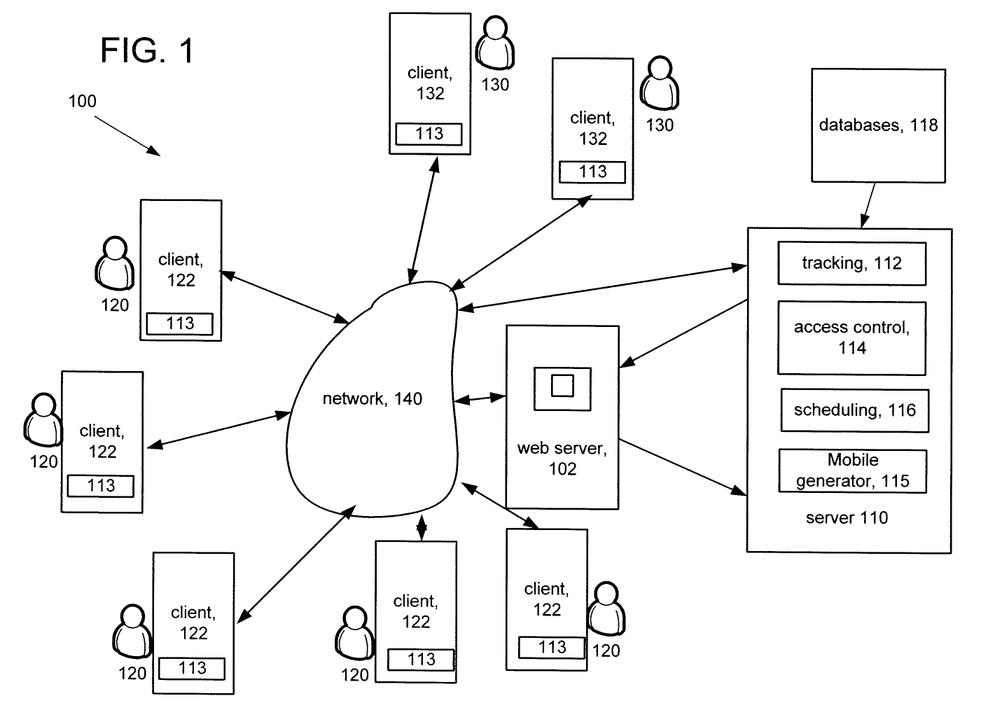

FIG. 1 shows an example system 100 implementing the brokerage service. The system 100 includes a computerized system or server 110 for making connections between consumers 120, at client systems 122, including mobile devices and PDAs, and service providers 130, at client systems 132, over a network 140, e.g., the Internet or other types of networks. The computerized system 110 operates as a service running on a web server 102. Client systems 122, 132 include processing devices, mobile devices, PDAs, and other computing devices.

Computerized system 110 includes application generator 115 that is configured to generate application 113 (e.g., a mobile application, an online application, and so forth) for execution on client systems 122, 132. As described herein, an application includes numerous files and graphical user interfaces that are downloaded onto client systems 122, 132 and allow client systems 122, 132 to interact with computerized system 110 and databases 118 over network 140, for example, without interfacing with web server 102.

Application 113 is also configured to communicate with tracking module 112 to determine the present availability of service providers, as described in further detail below. Based on present availability information received from tracking module 112, application 113 is further configured to render on client system 122 a graphical user interface that displays for consumers 120 a visual representation of the present availability of service provides.

Additionally, application 113 is further configured to communicate with scheduling module 116 to allow consumers 120 to schedule an appointment with a service provider, as described in further detail below. Generally, consumers 120 and service providers 130 are able to interact with brokerage system 100 as described in U.S. Pat. No. 7,590,550 through execution of application 113 on client systems 122, 132, rather than through execution of a web browser.

The computerized system 110 includes an availability or presence tracking module 112 for tracking the availability of the service providers 130. Availability or presence is tracked actively or passively. In an active system, one or more of the service providers 130 provides an indication to the computerized system 110 that the one or more service providers are available to be contacted by consumers 120 and an indication of the mode by which the provider may be contacted. In some examples of an active system, the provider's mobile device periodically provides an indication of the provider's availability (e.g., available, online, idle, busy) to the system 110 and a mode (e.g., text, voice, video, etc.) by which he can be engaged. In a passive system, the computerized system 110 presumes that the service provider 130 is available by the service provider's actions, including connecting to the computerized system 110 or registering the provider's local phone number of the provider's mobile device with the system. In some examples of a passive system, the system 110 indicates the provider 130 to be available at all times until the provider logs off, except when the provider is actively engaged with a consumer 120.

The computerized system 110 also includes one or more processes such as the tracking module 112 and a scheduling module 116. The system 110 accesses one or more databases 118. The components of the system 110 and the web server 102 may be integrated or distributed in various combinations as is commonly known in the art.

Using the system 100, a consumer 120 communicates with a provider 130. The consumers 120 and providers 130 connect to the computerized system 110 through a graphical user interface displayed on a mobile device and served by the web server 102 using client devices 122 and 132, respectively. Client devices 122 and 132 include any combination of mobile devices, PDAs, cellular phones and so forth. The client devices 122 and 132 enable the consumers 120 to input and receive information as well as to communicate via video, audio, and/or text with the providers 130.

The computerized system 110 provides information and services to the consumers 120 in addition to connecting them with providers 130. The computerized system 110 includes an access control facility 114, which manages and controls whether a given consumer 120 has privileges to access the system 110 and what level or scope of access to the features, functions, and services the system 110 provides.

The consumer 120 uses the system 100 to find out more information about a topic of interest or, for example, a potential medical condition. The computerized system 110 identifies service providers 130 that are available at any given moment to communicate with a consumer about a particular product, service, or related topic or subject, for example, a medical condition. The computerized system 110 facilitates communication between the consumer 120 and provider 130, enabling them to communicate, for example, via a data-network-facilitated video or voice communication channel (such as Voice over IP), mobile telephone network channels, and instant messaging or chat. In some examples, the availability of one or more providers 130 is tracked, and at the instant a consumer 120 desires to connect and communicate with a provider, the system 110 determines whether a provider is available through the provider's mobile device.

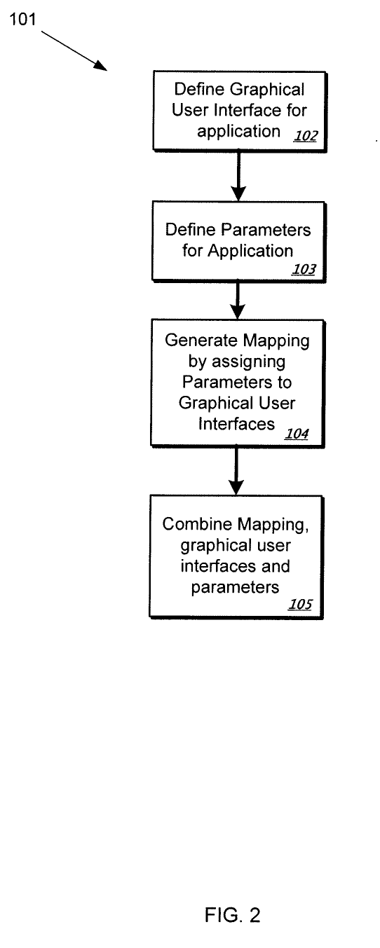

The system selects a mode of communication to use based in part on the relative utility of the various modes. The preferred mode for an engagement is for both the consumer 120 and the provider 130 to use graphical user interfaces, which are displayed on mobile devices. For example, consumers and providers launch chat sessions, voice calls, or video chats from within a graphical user interface, like that shown in FIGS. 2N and 2U.

If the provider 130 is not available, the system 110 identifies other available providers 130 that would meet the consumer 120's needs. The system 110 enables the consumer 120 to send a message to the consumer's chosen provider. The consumer also has the system 110 contact the consumer in the future when the chosen provider is available.

By way of illustration, application 113 generated by application generator 115 is executed by client systems122, 132 to connect members of healthcare plans with providers of healthcare products and services. For example, the service providers 130 include physicians, and the service consumers 120 include patients or other physicians. The service providers and service consumers also include lawyers and clients, contractors and homeowners, or any other combination of a provider of services and a consumer of services.

The system enables the consumer to search for providers that are available at the time the consumer is searching and enables the consumer to engage a provider on a transactional basis or for a one-time consultation. A consumer is able to engage a world-renowned specialist for a consultation or second opinion, even though the specialist is located too far away from the consumer to become a regular client, patient, or consumer. The consumer uses that specialist's advice when considering services by a local service provider. For example, a patient in a suburban town with a rare condition consults with a specialist in a distant city, and then, based on that consultation, selects a local physician for treatment.

FIG. 2 is a flowchart showing a process 101 of generating an application, including, e.g., application 113. In operation, application generator 115 defines (102) graphical user interfaces for application 113. Through the graphical user interfaces, a consumer is able to search for service providers, view an availability status of the service providers, and initiate a communication with the service providers.

Application generator 115 also defines (103) parameters for the application. A graphical user interface includes fields that correspond to parameters that are populated with parameter values. Using the techniques described herein, the fields of the graphical user interfaces are populated with the parameter values. Parameters include a set of values that are used in defining the content of a graphical user interface. In an example, a parameter includes a “presently available” parameter, which provides information indicating whether a service provider is presently available for a consultation with a consumer. In this example, the presently available parameter is associated with a value of “yes,” indicating that the provider is presently available for a consultation. In another example, the presently available parameter is associated with a value of “no,” indicating that the provider is not presently available for a consultation. In yet another example, the presently available parameter includes a list of service providers that are presently available for a consultation.

Still referring to FIG. 2, application generator 115 also generates (104) a mapping by assigning parameters to the fields of graphical user interfaces. The mapping includes a file (e.g., a text file or other file) with information specifying a correspondence between a field in a graphical user interface and a parameter. In an example, the mapping includes the following assignment: presently available parameter is assigned to presently available field of the presently available graphical user interface. In this example, application generator 115 assigns the presently available parameter to a field (“presently available field”) in a graphical user interface (“presently available graphical user interface”) that displays the present availability of service providers. An example of the presently available parameter inserted into the presently available field of the presently available graphical user interface is provided in the below Table 1.

TABLE 1

```
<start gui>
    Here are the physicians that are presently available
    presently available field ==
    <insert value (presently available parameter)>
<end gui>
```

In the foregoing example of Table 1, the presently available field of the graphical user interface is set to correspond to a value of the presently available parameter, as indicated by the following pseudo-code: “presently available field ==<insert value (presently available parameter)>.” In this example, the graphical user interface includes static elements (e.g., the text “Here are the physicians that are presently available”) and dynamic elements (e.g., <insert value (presently available parameter)>).

As described in further detail below, when the application is downloaded on a client system, the application includes numerous definitions for graphical user interfaces, including, e.g., the definition of the graphical user interface included in Table 1. The application renders a graphical user interface on client systems 122, 132 by receiving values for the dynamic elements from server 110 and generating visual representations of the static elements and the dynamic elements on client system 122, 132.

Application generator 115 also combines (105) together the mapping of parameters assigned to graphical user interfaces, the graphical user interfaces and the parameters. In particular, application 113 includes this combination of the mapping of parameters assigned to graphical user interfaces, the graphical user interfaces and the parameters.

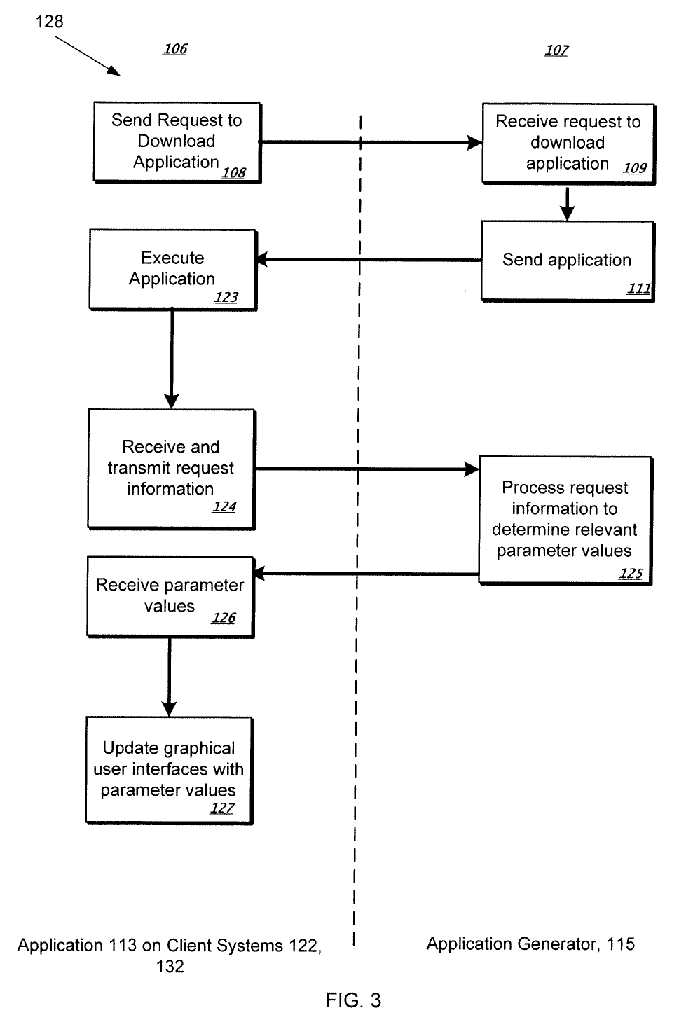

FIG. 3 is a flowchart showing a process 128 for interacting with the brokerage system 100 through application 113. In FIG. 3, process 128 is split into a left part 106, which is performed on client system 122 or client system 132, and a right part 107, which is performed on server 110 (e.g., the left part, or a portion thereof, is performed by application 113 and the right part, or a portion thereof, is performed by application generator 115).

In operation, consumer 120 associated with client system 122 sends (108) to application generator 115 a request to download application 113. Application generator 115 receives (109) the request to download application 113 and sends (111) application 113 to client system 122. Client system 122 executes (123) application 113 to cause application 113 to run on client system 122. A consumer 120 of client system 122 sends to application 113 a request for information, including, e.g., a request to consult with a service provider, a request to view a list of presently available service providers, and so forth. Application 113 receives and transmits (124) the request to application generator 115.

Application generator 115 processes (125) the request to determine parameters associated with the requested information. In an example where consumer 120 requests a list of available service providers, application generator 115 determines that information included in the request corresponds to the presently available parameter, as described herein. In this example, application generator 115 determines a value of the presently available parameter, for example, by sending a request to tracking module 112. Tracking module 112 responds with information specifying a list of service providers that are presently available.

Application generator 115 sends (not shown) to application 113 parameter values for the parameters associated with the requested information. In an example, application generator 115 sends to application 113 a list of presently available service providers, for example, by associating the value of the presently available parameter with the list. In another example, the numerous modules on server 110, including, e.g., tracking module 112 and scheduling module 116, passes information in the form of parameter values directly to application 113.

Application 113 receives (126) the parameter values and updates (127) graphical user interfaces with the received parameters values. In an example, application 113 updates the graphical user interface defined by the pseudo-code included in Table 1 with the value of the presently available parameter.

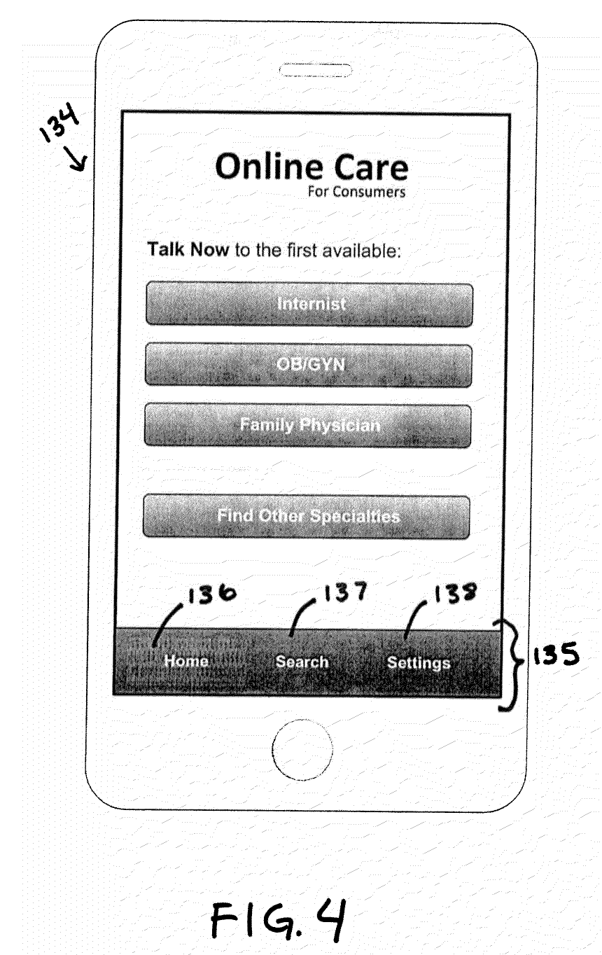

By executing actions 108, 123, 124, 126, 127, application 113 renders on client system 122 graphical user interfaces that display visual representations of a list of service providers that are presently available, credentials of service providers, a cost associated with a consultation, details of a communication with a service provider, and so forth (see e.g., FIGS. 4-8).

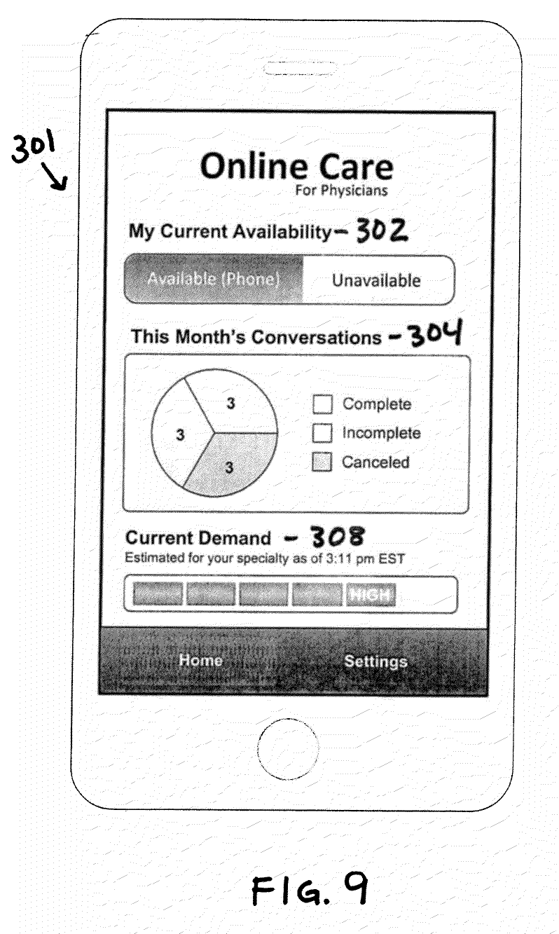

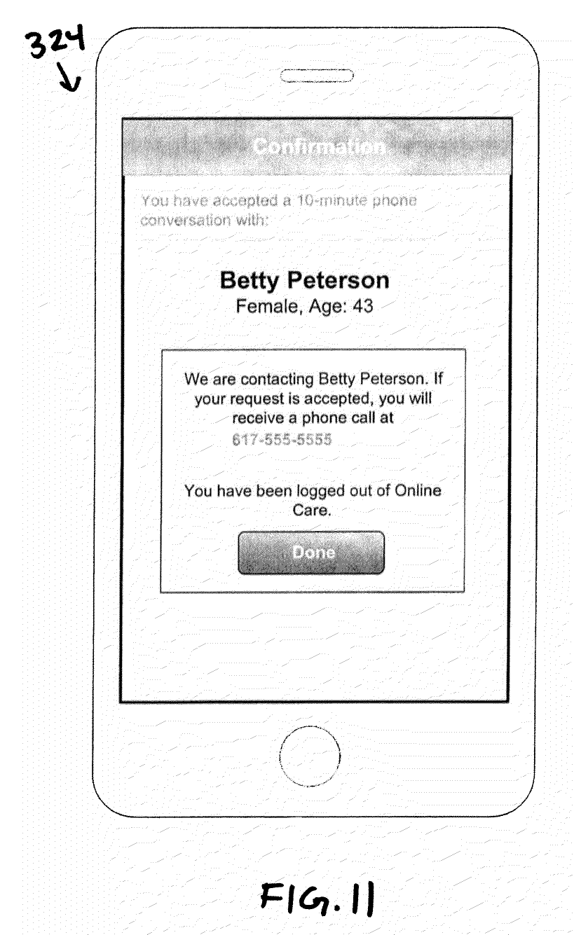

In a variation of FIG. 3, actions 108, 123, 124, 126, 127 are performed on client system 132 associated with service provider 130. Based on an execution of actions 124, 126, 127, application 113 renders on client system 132 graphical user interfaces that display visual representations of a request for a consultation with the service provider, whether a provider is currently engaged in a consultation, historical data representing a number of previous consultations with which the service provider has been engaged, information related to a medical history of a consumer with whom the service provider is engaged in a consultation, and so forth (see e.g., FIGS. 9-11).

Providers participating in the brokerage network have several states of availability over time. States in which the provider are available include on-line, in which the provider is logged-in and accepts new engagements in any mode, on-line (busy), in which the provider is logged-in but is currently occupied in a video or telephonic engagement, and scheduled, in which the provider is offline but is scheduled to be online at a designated time-point and pre-schedule engagements for it. While not online, the provider takes messages as in offline state. Other states include off-line, in which the provider is not logged in but takes message-based engagements (i.e., asynchronous engagements), out-of-office, in which the provider is not accepting engagements or messages, and standby, in which the provider is offline and is paged to Online status by the brokerage network if traffic load demands it (in some examples, consumers see this state as offline).

The operating business model for the provider network employs a remuneration scheme for providers that helps assure that the consumers find providers in designated professional domains (e.g., pediatrics) in the online mode. For example, selected providers are remunerated for being in the standby mode to encourage their on-line availability in case of low discretionary availability by other providers in their professional domain. Standby providers are also called into the on-line state when the fraction of on-line (busy) providers in their professional domain exceeds a certain threshold. In some examples, the transition of providers from standby to online and back to standby (in case of over capacity or idle capacity) is an automated function of the system.

The tracking module 112 transfers 154 information about the availability and the communication capability of the consumers 120 and the providers 130 to the scheduling module 116 using, for example, one or more well-known presence protocols, such as Instant Messaging and Presence Service (IMPS), Session Initiation Protocol (SIP) for Instant Messaging and Presence Leveraging Extensions (SIMPLE), and the Extensible Messaging and Presence Protocol (XMPP).

As noted, the system 100 includes access control facilities 114 that control how consumers 120 access the system and to what extent or level the services provided by the system are made available to consumers. The system 100 also stores and provides access to consumer information (e.g., contact information, credit and financial information, credit card information, health information, and other information related to the consumer and the services purchased or otherwise used by the consumer) and provider information (e.g., physician biographies, product and service information, health related content and information and any information the provider or the health plan wants to make available to members) and the access control facility 114 prevents unauthorized access to this information. In some examples, the system 100 exports the consumer information for use in a provider's office or other facility.

The system 100 interacts with consumers and available data sources to position and direct their health matters to appropriate care providers. Consumers use various tools of physician and provider profiling to exercise choice in selecting the providers they wish to interact with. The brokerage facilitates the communication between the consumer and his selected providers, allowing the consumer to follow-up as needed to establish a comfort level in his care. The brokerage supports transfer of these communications and any other results of the eVisit to non-virtual care points if such escalation is needed.

The brokerage is considered a first tier of medical care that is made available to consumers at home or at other locations. This first tier precedes typical entry points into a medical care setting, e.g., a physician's office or an emergency room. The brokerage enables consumers to explore concerns on, new or existing medical issues without the need to incur the time, cost, and emotional burden typically associated with the office visits or trips to the emergency room. To deliver such a comfort level, the system provides immediate access to tools that help define health issues, as well as, access to the appropriate automated and human mediated interventions. Consumers discretionally engage (or escalate) the level of care they need to gain confidence in their management of such issues. The consumers' choices in this area span both the type of credentials of the provider they interact with (e.g., a nurse versus a board certified specialist), as well as the level of intensity (mode and frequency) of their communications (e.g., messages versus full video dialogue). The brokerage exports the information and workup gained during an encounter to a subsequent tier of services, such as a specific medical office or the ER (as well as care management services if offered by the consumer's health plan, hospitals and so forth). As such, the brokerage manages more costly medical service consumption (demand management) and serves as a pervasive tool for impacting basic medical care and follow-up and encourages appropriate health behaviors for the customer population at large.

There are various models for how consumers gain access to the system. Consumers purchase access to the system through a variety of models, including direct payment or as part of their insurance coverage. Health plans provide access to their members as part of their service or as an optional added benefit. In some examples, health plans receive information about their members' use of the brokerage to allow, for example, better allocation of resources and overall management of member's health care consumption. Employers purchase access to the brokerage for their employees through whichever health plans the employer offers. Self-insured employers purchase access for their employees directly with the brokerage. Providers are compensated in several ways and offer their services to the brokerage either independently or as part of a framework such as a provider network.

Similarly, there are numerous ways the brokerage is packaged. As a health plan benefit, the brokerage expands a health plans ability to manage health care service consumption by their members. A health plan provides access to the brokerage through an existing web portal, accessible over mobile devices, through which members access benefit information and interact with their health plan. As an employee benefit, the brokerage supplements the employee's health coverage and is presented, for example, through a human resources web site, accessible over mobile devices. In a direct-to-consumer situation, consumers access the brokerage directly through its own graphical user interface displayed on a mobile device. In some examples, the brokerage is implemented as an enterprise software system for a call center, such as one operated by a health care provider. Linked to other institutional users of the system (e.g., other participating providers), this allows the provider to provide services to its patients that it cannot offer itself, such as 24-hour specialty consultations. The brokerage is also used by a provider practice to allows its practitioners to provide care to the brokerage's members (and generate revenue) during off-hours or as a preliminary stage to office visits. This eliminates the need for an office visit with a primary care physician just to get a referral to a specialist.

The brokerage provides compensation for products and services provided. Access to the system 100 is provided on a subscription basis, with consumers paying a fee (either directly or indirectly through another party, such as a healthcare plan or health insurance provider) to be provided with a particular level of access to the system. In exchange for providing products or services, the service provider receives compensation from the consumer or from an organization that pays for the products or services on behalf of the consumer, such as a health plan or a health insurance company. In instances in which the consumer pays directly, the operator of the interface to the system that connected the consumer to the service provider is compensated. In one embodiment, the consumer pays the operator, which keeps a portion (e.g., a percentage, a flat fee, or a co-pay) and pays the remainder to the service provider. In another embodiment, the consumer or the service provider pays a flat fee or percentage of the fee for the engagement to the operator. Where the service provider's compensation is paid by a health plan or insurance company, the operator is paid a flat fee or a percentage of the fee for the engagement transaction by the health plan or insurance company. Alternatively, the consumer or the service provider or both pays a fee (a co-pay or service fee) to the operator for providing the connection.

### Graphical User Interfaces

Application 113 includes various graphical user interfaces that are displayed on client systems 122, 132. Some of the interfaces are tailored for the client systems 122 where the consumer is interacting, whereas others are tailored for the client systems 132 where the provider is interacting. Application 113 is configured to enable consumers 120 to interact with the brokerage system 100, for example, by viewing available service providers and initiating a communication with a service provider. To enable a consumer to interact with the brokerage system 100 and/or components of the brokerage system 100 (e.g., application generator 115, tracking module 112, etc.), application 113 includes several consumer graphical user interfaces (e.g., FIGS. 4-8) that are displayed on client system 122 associated with consumer 120.

Application 113 is also configured to enable service providers 130 to interact with the brokerage system 100 and with client systems 122 of consumers 120, including, viewing consultation statistics associated with the service provider, accepting a consumer's request for a consultation, engaging in a consultation, and so forth. To enable a service provider to interact with the brokerage system 100, application 113 includes numerous service provider graphical user interfaces (e.g., FIGS. 9-11) that are displayed on client system 132 associated with service provider 130. Using the techniques described herein, application 113 uses parameter values received from server 110 (or application generator 115, tracking module 112, etc.) to populate fields of the graphical user interfaces and to render the graphical user interfaces in client systems 122, 132.

### The Consumer Graphical Interface

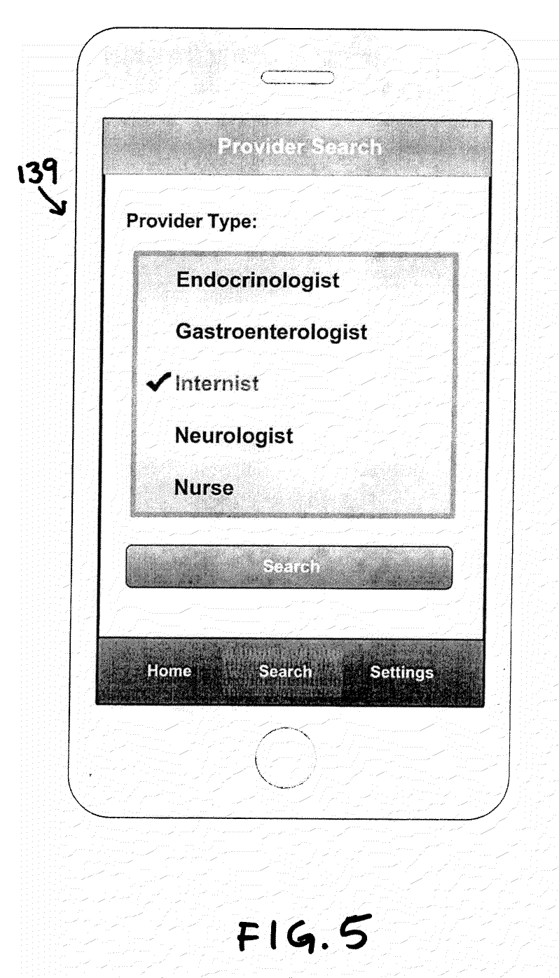

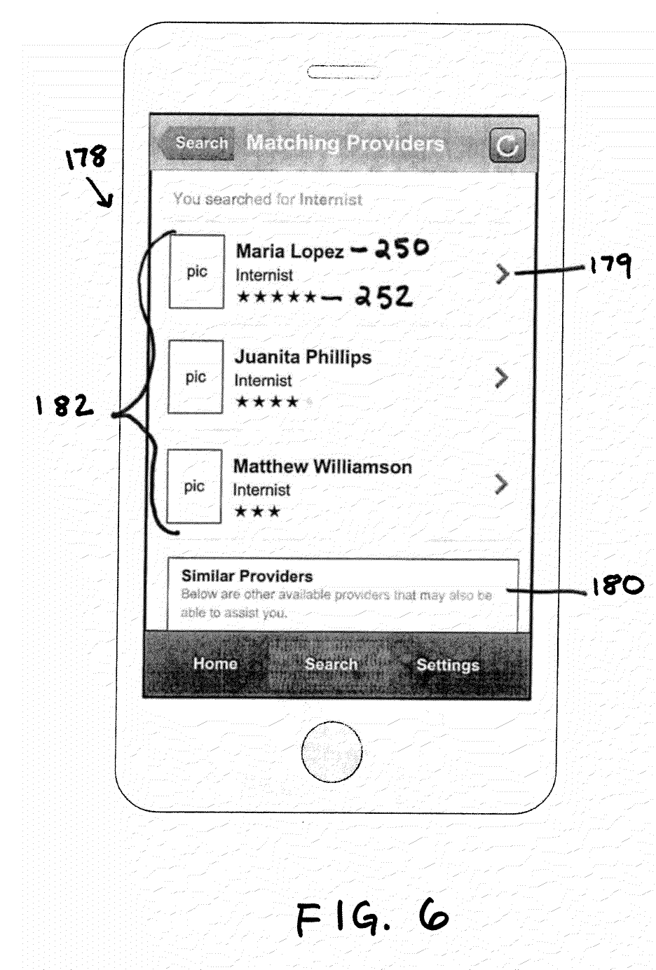

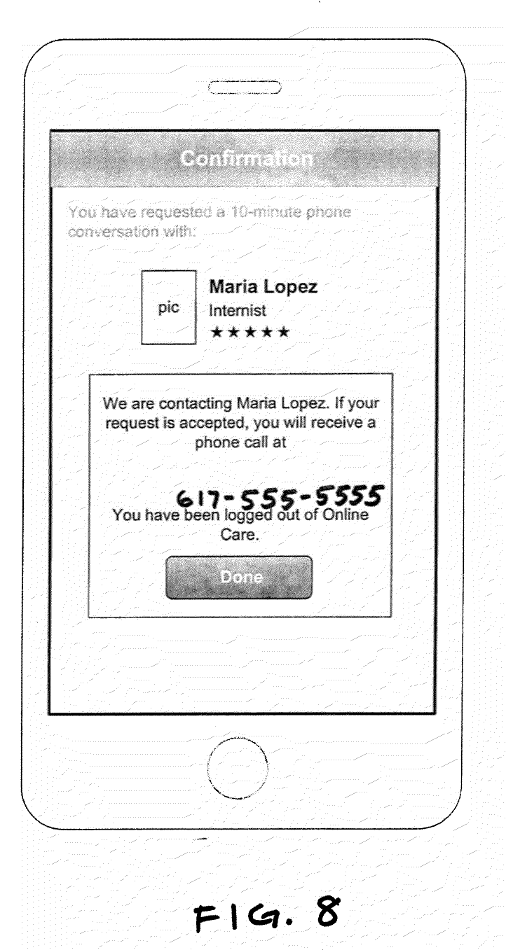

Referring to FIGS. 4-8, graphical user interfaces, as rendered on display screen on a mobile device are used by a consumer of services to access services of the brokerage system as well as during a consultation with a service provider. For example, a graphical user interface (that when rendered on a mobile device) displays a login screen through which the consumer logs into the brokerage system. Another graphical user interface displays a list of the various types of service providers available for a consultation (FIGS. 4-5), a list of matching providers (FIG. 6), as well as the details of a communication between the consumer of services and the service provider (FIG. 8).

FIG. 4 shows a graphical user interface 134 generated by the brokerage system for display on mobile devices. Server 110 sends graphical user interfaces like the graphical user interface 134 to the consumer 120 and the provider 130 and receives responses from the consumer 120 and the provider 130. In some examples, the application server provides a predefined sequence of graphical user interfaces to the consumer 120 or the provider 130. The graphical user interface 134 includes various elements to enable the consumer 120 to input information. These interface elements include buttons, links and text to enable the consumer 120 to select information and to navigate between the graphical user interfaces. Other standard elements (not shown) include text boxes to receive textual information and menus (such as drop-down menus) to enable the consumer 120 to select information from a menu or list.

Graphical user interface 134 includes a row 135 of links 136, 137, 138. By selecting, such as by manually touching or tapping the portion of the display screen on the mobile device corresponding to the link, one of the links 136, 137, 138 another, different graphical user interface is displayed.

Referring to FIG. 5, when a consumer selects link 137, graphical user interface 139 is displayed. Referring to FIGS. 2-7, the row 135 of links 136, 137, 138 is displayed for various graphical user interfaces.

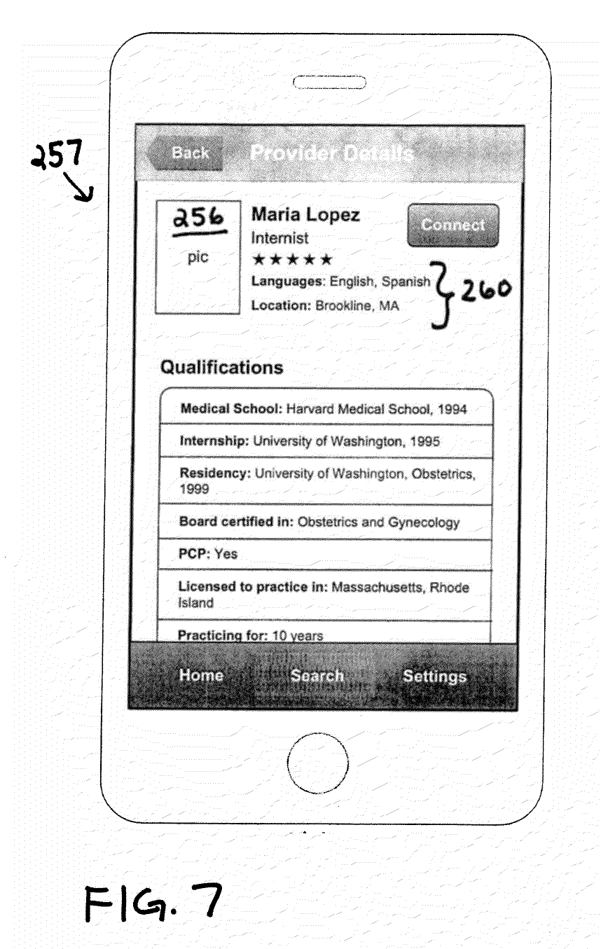

Referring to FIG. 6, each of the matching service providers is associated with a link, such as link 179, that when selected, such as by manually touching or tapping the portion of the display screen on the mobile device corresponding to the link, causes the mobile device to display another graphical user interface, such as graphical user interface 257 (FIG. 7), which includes the details, such as qualifications, of the service provider associated with the selected link Another link 180 is displayed that when selected, such as by manually touching or tapping the portion of the display screen on the mobile device corresponding to the link, causes the graphical user interface 178 (FIG. 6) to display additional service providers (not previously displayed due to the size constraints of the display screen associated with the display device).

### The Service Provider Graphical User Interface

Referring to FIGS. 9-11, a display screen on a mobile device displays the various graphical user interfaces accessed by a provider of services during use of the brokerage system and during a consultation with the consumer. For example, a graphical user interface 306, 307 that when rendered on a mobile device displays a login screen through which the provider logs into the brokerage system.

Referring to FIG. 9, another graphical user interface 301, that when rendered on a mobile device, displays an overview of the modes of communication through which the provider is available, such as by phone 302, an overview 304 of the number of communications the service provider has participated in, and a current demand T for the service provider's area of expertise.

Additionally, through a graphical user interface (not shown) displayed on the display screen of a mobile device, the provider reviews his account status, system settings, and preferences. The provider also accesses his profile and user satisfaction and statistics as they are available to consumers. The brokerage system also connects to financial services associated with the provider's participation in the brokerage. This includes status of charges, submission of plan claims (e.g., for CPT code 0074T for eVisits in a health care setting) and claim processing status. In some examples, depending on the mode of deployment of the brokerage from the health plan standpoint, real-time claim information is available.

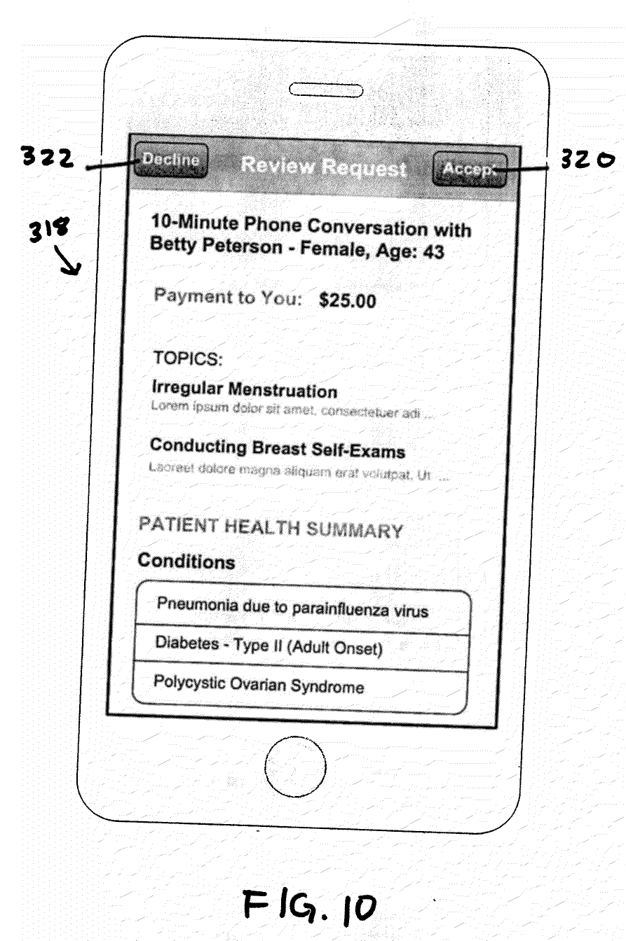

Referring to FIG. 10, graphical user interface 318 (that when rendered on a mobile device) displays the details of the request, such as the amount of payment received by the service provider, the length of time of the communication (e.g., 10 minutes) and the various topics to be discussed during the communication. The graphical user interface 318 displays a link 320 through which the service provider accepts the communication request, thereby initiating the establishment of a communication channel between the consumer and provider. Another link 322 is also displayed. By selecting the link 322, the service provider declines the request for the communication. If the service provider selects link 320, then another graphical user interface 324 (FIG. 10) (that when rendered on a mobile device) displays a confirmation of the service provider's acceptance of the consumer's request.

The communication channel is established between the service provider and the consumer by the brokerage system in various ways, including initiating a telephone call between the service provider and the consumer, as described in my co-pending U.S. patent application Ser. No. 12/105,784, Published as “US-2009-0262919-A1” and incorporated herein by reference, and by establishing a text-based communication, as described in my issued U.S. Pat. No. 7,590,550. In some examples, the communication channel is established between the consumer's mobile device and the provider's mobile device.

Initiation of an Engagement

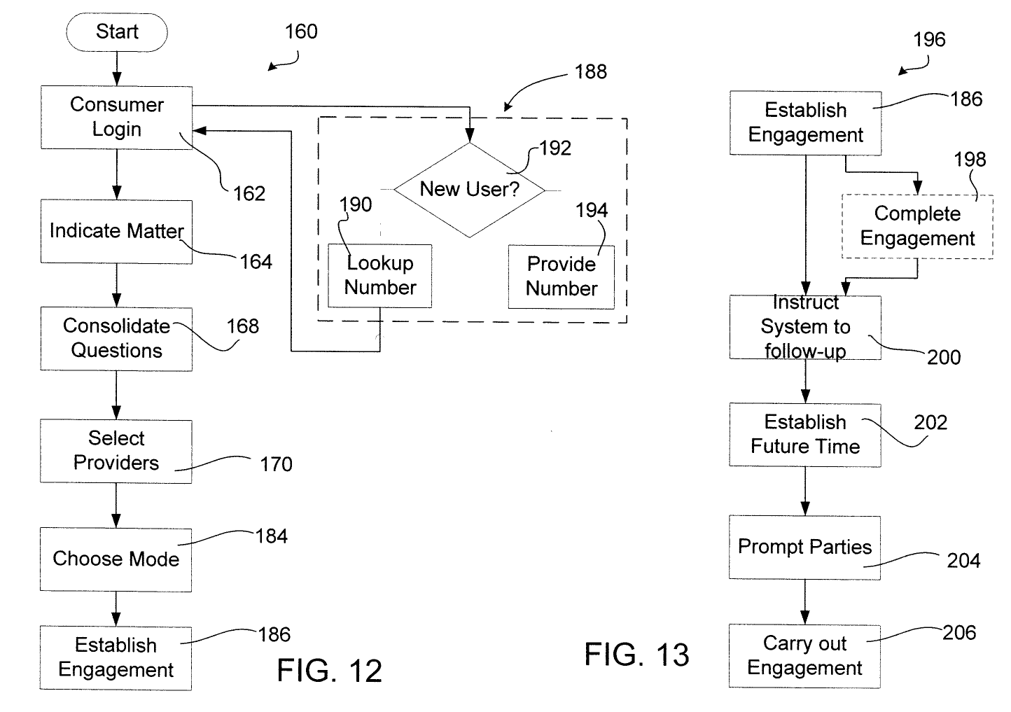

A consumer 120 engages with the brokerage system 100 to access a service provider 130. Several types of engagements exist. Examples of these are described with respect to flowcharts in FIGS. 12-13. Referring now to FIGS. 12-13, a process 160 for establishing a consumer-initiated engagement and a process 196 for establishing a communication are shown. In a consumer-initiated engagement, a consumer logs in 162 and communicates 164 a new matter he desires assistance or guidance on to the brokerage, for example, a health concern. For example, this is done over a graphical user interface that is rendered through application 113. A results graphical user interface 178, in FIG. 6, allows the consumer to select a specific provider from a list of providers identified based on the search criteria. Once a provider is selected and a mode of engagement is chosen the scheduling module establishes the new engagement. In some examples, the brokerage associates a unique identifier with participating consumers which is used in subsequent interactions with the brokerage, such as associating records from multiple engagements. The consumer's health plan membership number or other similar, pre-existing identification is used. If the consumer does not already have a number, one is generated. The unique identifier is used by the consumers to save their planned engagement for later retrieval.

Provider Selection

One capability of the brokerage is to extend a retail-like experience to the consumer. Consumers are able to spend time on the system to explore its participating providers whether they are currently available or are expected to be available at some other time. While the system assists the consumer in identifying the most appropriate providers (see the consumer advisor function, below), it also allows the consumer to filter the provider list based on his preference and access a view of a provider availability matrix that changes as providers go on and off line.

An example of a graphical user interface by which consumers select providers in a variety of ways, including specialty and area of practice (e.g., “internist” or “family physician”), is shown in FIGS. 4-5. Consumers select providers according to attributes of the provider, such as a geographical area where the provider is located or which professional organizations have accredited the provider (e.g., whether a doctor has board certification in cardiology).

Once the consumer enters her search criteria, the results are shown on the graphical user interface 178 in FIG. 6. A list 182 of providers is presented. This list includes each provider's name 250 and rating 252 and whether the provider is available. For a selected provider, additional details are shown, including her picture 256, specialty, demographic information 260, qualifications and affiliations, as shown in FIG. 7. Tools allow the consumer to initiate or schedule an engagement.

Providers already associated with the consumer appear on the consumers' short list. Association is based on historical engagements and extends to the health plan's feed of claims (i.e., all providers that submitted claims for the consumer). When reviewing the list of historical engagements, consumers are able to access the engagement audit and the ranking they have attributed to any engagements in the past.

In certain modes of deployment, there are functional attributes that impact the consumer's selection. In most health-plan distribution modes, consumers opt (or be limited) to see only providers that are “in-network” according to their insurance coverage product. Selecting an “out-of-network” provider incurs higher out-of-pocket costs. Another example relates to a deployment of the system in disease management and health coaching settings (e.g., a call center). In this case, the plan requires that the consumer select only nurses that are associated with the disease management program with which the consumer is associated.

Regulations introduced by the federal government in August, 2006, require all federal bodies offering medical coverage (including Medicare, Medicaid, and military, and federal employee plans) to publish their ratings of health service providers (physicians and hospitals) to the general public. The system allows the consumer to search such sites automatically for a selected provider prior to an engagement. Other sources of reference data include state publications on morbidity, mortality, and legal actions against providers, or databases maintained by third parties.

Once a consumer has defined a collection of criteria to filter and find a provider, the system offers tools to shorten the process in the future. Consumers are able to save criteria-sets as named searches and benefit from notifications when a search list surpasses a certain level of availability that encourages the consumer to log in and communicate with a provider.

Interface with External Data Sources

To facilitate engagements between the consumer and the provider, the system acquires information from available systems automatically and uses the information to prepare providers at the beginning of an engagement. Such interfaces include both synchronous (e.g., web services) and batch updates from, in the example of health care, eligibility data, claims data, Pharmacy Benefit Management (PBM) information, predictive modeling, provider feeds relevant for consumer referrals, other standard-coding feeds using, e.g., ICD, CPT, HCPCS, NDC, SNOMED, or LOINC, formulary information relevant for Rx drug choice determination and preference, Customer Relations Management systems (CRM), and external messaging systems and queues (e.g.,

The brokerage offers providers the ability to redirect messages or requests for appointments to SMS-compatible cellular phones and other mobile devices. In this mode, the provider associates a cell phone number with his account and establishes the type of information that the system sends to the mobile device. Such information includes engagement-related notifications as well as system-related notifications (e.g., an announcement about a high-traffic state asking providers to make themselves available and offering a higher fee to do so).

Embodiments can be implemented in digital electronic circuitry, or in computer hardware, firmware, software, or in combinations thereof. Apparatus of the invention can be implemented in a computer program product tangibly embodied or stored in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method, the method comprising:
receiving by a first mobile device an application that executes on the first mobile device associated with a consumer, the application comprising a plurality of graphical user interfaces, the graphical user interfaces having one or more fields that are populated with information received from a central, brokerage system;
sending by the application executing on the first mobile device a request to consult with a service provider;
populating one or more fields of the plurality of graphical user interfaces with information received from the central, brokerage system, to render a visual representation of present availability of one or more service providers;
receiving by the application a selection of a particular service provider; and
establishing through the brokerage system by the application a communication channel between the first mobile device and a second mobile device associated with a selected service provider.

2. The computer-implemented method of claim 1, further comprising:
receiving from the first mobile device a request for the application; and
sending the application to the first mobile device.

3. The computer-implemented method of claim 1, wherein a first graphical user interface in the plurality of graphical user interfaces comprises:
a link for each corresponding available service provider, with selection of the link causing generating of a second graphical user interface to be displayed on the first mobile device, the second graphical user interface including one more details of a service provider associated with the selected link.

4. The computer-implemented method of claim 1 further comprises:
generating, by one or more computers, a first graphical user interface that when rendered on the first mobile device displays one or more first links through which the consumer searches for available service providers.

5. The computer-implemented method of claim 1 further comprising:
generating, by one or more computers, a particular graphical user interface that when rendered on the second mobile device displays, for the service provider, a first link, selection of which indicates that service provider accepts the request, and a second link, selection of which indicates that the service provider declines the request.

6. A computer program product embedded in a computer readable medium for providing broker services to consumers and service providers, the computer program product comprising instructions for causing a first mobile device to:
receive an application that executes on a first mobile device associated with a consumer, the application comprising a plurality of graphical user interfaces, the graphical user interfaces having one or more fields that are populated with information received from a central, brokerage system; and
configure the application to:
send a request to consult with a service provider;
populate one or more fields of the plurality of graphical user interfaces with information received from the central, brokerage system to render a visual representation of present availability of the one or more service providers;
receive a selection of a particular service provider; and
establish through the brokerage system a communication channel between the first mobile device and a second mobile device associated with a selected service provider.

7. The computer program product of claim 6, further comprising instructions to:
receive from the first mobile device a request for the application; and
send the application to the first mobile device.

8. The computer program product of claim 6, wherein a first graphical user interface comprises:
a link for each corresponding available service provider, with selection of the link causing generating of a second graphical user interface to be displayed on the first mobile device, the second graphical user interface including one more details of a service provider associated with the selected link.

9. The computer program product of claim 6, further comprising instructions for causing the computer to:
generate a first graphical user interface that when rendered on the first mobile device displays one or more first links through which the consumer searches for available service providers.

10. The computer program product of claim 6, further comprising instructions for causing the computer to:
generate a particular graphical user interface that when rendered on the second mobile device displays, for the service provider, a first link, selection of which indicates that service provider accepts the request, and a second link, selection of which indicates that the service provider declines the request.

11. An apparatus comprising:
a processor; and
a computer program product embedded in a computer readable medium for providing broker services to consumers and service providers, the computer program product comprising instructions for causing the processor to:
receive an application that executes on a first mobile device associated with a consumer, the application comprising a plurality of graphical user interfaces, the graphical user interfaces having one or more fields that are populated with information received from a central, brokerage system; and
configure the application to:
send a request to consult with a service provider;
populate one or more fields of the plurality of graphical user interfaces with information received from the central, brokerage system to render a visual representation of present availability of the one or more service providers;
receive a selection of a particular service provider; and
establish through the brokerage system a communication channel between the first mobile device and a second mobile device associated with a selected service provider.

12. The apparatus of claim 11, wherein a first graphical user interface comprises:
a link for each corresponding available service provider, with selection of the link causing generating of a second graphical user interface to be displayed on the first mobile device, the second graphical user interface including one more details of a service provider associated with the selected link.

13. The apparatus of claim 11, further comprising instructions for causing the processor to:
generate a first graphical user interface that when rendered on the first mobile device displays one or more first links through which the consumer searches for available service providers.

14. The apparatus of claim 11, further comprising instructions for causing the processor to:
generate a particular graphical user interface that when rendered on the second mobile device displays, for the service provider, a first link, selection of which indicates that service provider accepts the request, and a second link, selection of which indicates that the service provider declines the request.

15. The computer-implemented method of claim 1, further comprising:
generating a particular graphical user interface that when rendered on the second mobile device displays for the service provider a visual representation of a measure of estimated demand for a specialty associated with the service provider.

16. The computer-implemented method of claim 15, wherein the particular graphical user interface when rendered on the second mobile device further displays:
a link, selection of which allows the service provider to update an availability status of the service provider, and
a visual representation of a number of consultations with which the service provider has been engaged, with the number of consultations comprising one or more of a number of complete consultations, a number of incomplete consultations, and a number of cancelled consultations.

17. The computer program product of claim 6, further comprising instructions for causing the computer to:
generate a particular graphical user interface that when rendered on the second mobile device displays for the service provider a visual representation of a measure of estimated demand for a specialty associated with the service provider.

18. The computer program product of claim 6, wherein a particular graphical user interface when rendered on the second mobile device displays:
a link, selection of which allows the service provider to update an availability status of the service provide, and
a visual representation of a number of consultations with which the service provider has been engaged, with the number of consultations comprising one or more of a number of complete consultations, a number of incomplete consultations, and a number of cancelled consultations.

19. The computer program product of claim 6, further comprising instructions for causing the computer to:
generate a particular graphical user interface that when rendered on the second mobile device displays for the service provider a visual representation of one or more of suggested topics to discuss with the consumer of services, a patient health summary, medical conditions associated with the consumer of services, and medication associated with the consumer of services.

20. The apparatus of claim 11, further comprising instructions for causing the processor to:
generate a particular graphical user interface that when rendered on the second mobile device displays for the service provider a visual representation of a measure of estimated demand for a specialty associated with the service provider.
